(19) United States
(12) Patent Application Publication
(10) Pub. No.: US 2013/0033195 A1
(43) Pub. Date: Feb. 7, 2013

(54) LIGHT SOURCE APPARATUS

(71) Applicant: Chao-Jung Liao, Taipei City (TW)

(72) Inventor: Chao-Jung Liao, Taipei City (TW)

(73) Assignee: EVERGREEN OPTRONICS INC., Taipei City (TW)

(21) Appl. No.: 13/342,989

(22) Filed: Jan. 4, 2012

(30) Foreign Application Priority Data
Aug. 5, 2011 (TW) 100214541

(51) Int. Cl. H05B 37/02; F21L 4/00; F21L 4/08; F21V 21/002

(52) U.S. Cl. 315/294; 362/217.14; 362/157; 362/183

(57) ABSTRACT

A light source apparatus includes at least a light-emitting module. The light-emitting module includes a hollow rod-shaped base and a plurality of LED chips. The hollow rod-shaped base has an outer surface and an inner surface opposite to the outer surface, in which the inner surface surrounds a space. The LED chips are disposed in flip chip bonding way on the outer surface of the hollow rod-shaped base, in which the LED chips are disposed surrounding the space.

### CROSS-REFERENCE TO RELATED APPLICATION

This application claims the priority benefit of Taiwan application serial no. 100214541, filed on Aug. 5, 2011. The entirety of the above-mentioned patent application is hereby incorporated by reference herein and made a part of this specification.

### BACKGROUND

1. Field of the Utility Model

The invention generally relates to a light source apparatus, and particularly, to a light source apparatus with light emitting diode chips (LED chips).

2. Description of Related Art

Along with the progress of modern semiconductor science and technology, LEDs have been broadly used to provide electronic apparatuses such as traffic sign light, mega-size display board, scanner and LCD display with required light sources. The LED has advantages of fast response (10⁻⁹ seconds or so), small size, power-saving, low pollution (no mercury contained), high reliability and adaptation for mass production, it has been broadly applied as an indicator or a light source in home appliances and various equipments. In recent years, LEDs are developed towards rich colors and high luminance and extended in applications to mega-size outdoor display board, traffic sign light and other related fields. In the future, LEDs may even become a major illustration light source with energy-saving and protection of the environment functions to replace the traditional fluorescent lamp tube, energy-saving bulb and incandescent bulb.

The LED power is gradually advanced with the technology progress, so that the light-emitting intensity of an LED gets more and more strong and, meanwhile, the heat-dissipating problem thereof becomes more and more important. In general speaking, an LCD packaged with the conventional wire bonding process has a poor heat-dissipating efficiency and the produced heat is hard to be delivered onto the substrate bonded with the LCD and easily accumulated up. In order to reduce the problem of poor heat-dissipating efficiency, the prior art usually uses heat-dissipating fins for heat-dissipating. However, the heat-dissipating fins often limit the shape modification of an LCD lamp, so that the lamp appears not have nice look. In addition, a wire bonding way usually makes the thickness of an LED package too thick, which limits the appearance and application of the LED lamp.

### SUMMARY OF THE DISCLOSURE

Accordingly, the invention is directed to a light source apparatus, which has good heat-dissipating efficiency and better appearance.

An embodiment of the invention provides a light source apparatus, which includes at least one light-emitting module. The light-emitting module includes a hollow rod-shaped base and a plurality of LED chips. The hollow rod-shaped base has an outer surface and an inner surface opposite to the outer surface, in which the inner surface surrounds a space. The LED chips are disposed in flip chip bonding way on the outer surface of the hollow rod-shaped base, in which the LED chips are disposed surrounding the space.

In the light source apparatus of the embodiment of the invention, since the LED chips are disposed in flip chip bonding way on the outer surface of the hollow rod-shaped base, so that the light source apparatus has both better appearance and good heat-dissipating efficiency. In addition, in the light source apparatus of the embodiment of the invention, since the LED chips are disposed surrounding the space formed by the hollow rod-shaped base, the appearance and the application level of the light source apparatus are effectively advanced.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of a light source apparatus according to an embodiment of the invention.

FIG. 2A is a three-dimensional diagram of one of the light-emitting modules in FIG. 1.

FIG. 2B is a cross-sectional diagram of the light-emitting module in FIG. 1.

FIG. 3 is a schematic diagram of a light source apparatus according to another embodiment of the invention.

FIG. 4 is a schematic diagram of a light source apparatus according to yet another embodiment of the invention.

FIG. 5 is a three-dimensional diagram of a light source apparatus according to yet another embodiment of the invention.

FIG. 6 is a cross-sectional diagram of a light-emitting module according to yet another embodiment of the invention.

### DESCRIPTION OF THE EMBODIMENTS

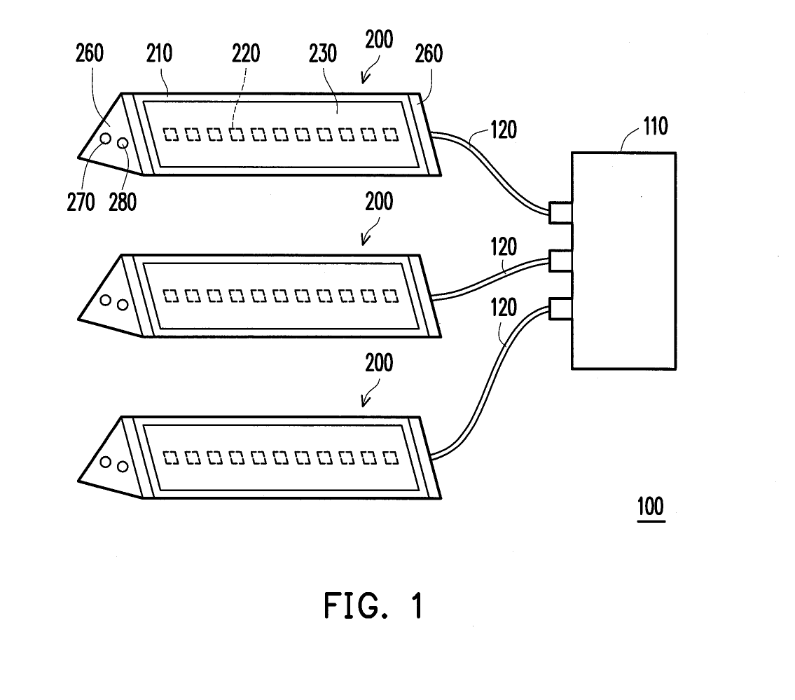

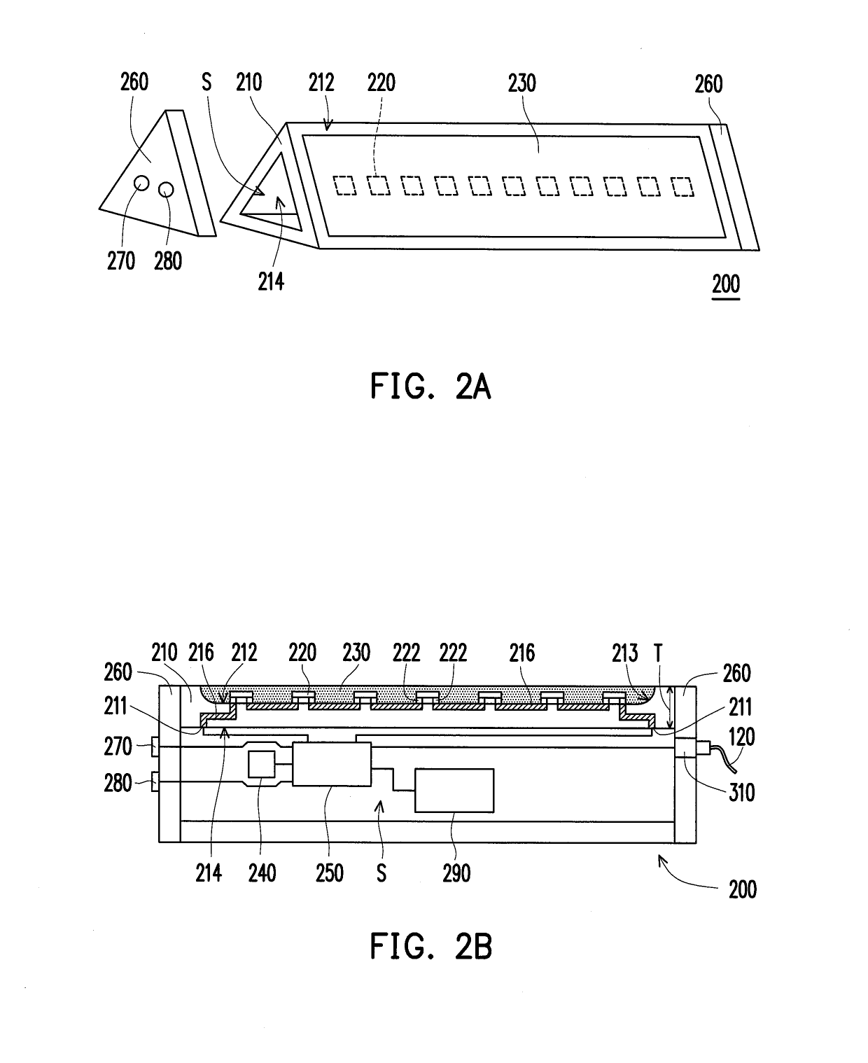

FIG. 1 is a schematic diagram of a light source apparatus according to an embodiment of the invention, FIG. 2A is a three-dimensional diagram of one of the light-emitting modules in FIG. 1, and FIG. 2B is a cross-sectional diagram of the light-emitting module in FIG. 1. For better understanding, in FIG. 2A, a cap is taken away from the hollow rod-shaped base of the light-emitting module. Referring to FIGS. 1, 2A and 2B, a light source apparatus 100 of the embodiment includes at least one light-emitting module 200 (a plurality of light-emitting modules 200 is shown in FIG. 1 as an example). Each of the light-emitting modules 200 includes a hollow rod-shaped base 210 and a plurality of LED chips 220. The hollow rod-shaped base 210 has an outer surface 212 and an inner surface 214 opposite to the outer surface 212, in which the inner surface 214 surrounds a space S. The LED chips 220 are disposed in flip chip bonding way on the outer surface 212 of the hollow rod-shaped base 210, in which the LED chips 220 are disposed surrounding the space S. In more details, the LED chips 220 are bonded with a conductive trace 216 on the hollow rod-shaped base 210 through a plurality of bumps 222.

In the embodiment, the material of the hollow rod-shaped base 210 includes extruded aluminium alloy, aluminium alloy, heat-conducting plastic or ceramic. In addition, in the embodiment, the hollow rod-shaped base 210 is in polygon pillar shape. For example, the hollow rod-shaped base 210 is in triangle pillar shape.

In the embodiment, the light-emitting module 200 further includes a phosphorous layer 230 disposed on the outer surface 212 and covering the LED chips 220. The phosphorous layer 230 is able to convert light in a shorter wavelength emitted from the LED chips 220 into light in a longer wavelength. For example, the LED chips 220 can emit blue light, the phosphorous layer 230 can convert the blue light into yellow light, and the blue light emitted from the LED chips 220 and the yellow light converted by the phosphorous layer are blended together to form white light, which the invention is not limited to. In other embodiments, the color of the light emitted from the LED chips 220 and the color of the light converted by the phosphorous layer 230 can be other appropriate colors.

In the embodiment, the light-emitting module 200 further includes a power unit 240 disposed in the space S and is electrically connected to the LED chips 220. For example, the power unit 240 is, for example, a rechargeable battery. In other embodiments, the power unit 240 can be a non-rechargeable battery as well. However, the invention does not limit that the power of the light-emitting module 200 must be provided by a battery. In the embodiment, the light-emitting module 200 further includes a driving circuit board 250 disposed in the space S and electrically connected to the LED chips 220. The driving circuit board 250 can be electrically connected to an external power which provides the light-emitting module 200 with a required electric power. The external power is, for example, a home AC power, various AC/DC power supplies, power supplied by a computer host or other appropriate powers. For example, the light source apparatus 100 can further include a control unit 110 and the driving circuit board 250 is electrically connected to the control unit 110. In the embodiment, the control unit 110 is electrically connected to the driving circuit board 250 through a universal serial bus (USB). However, in other embodiments, the light-emitting module 200 may have a lamp base electrically connected to the driving circuit board 250, and the control unit 110 may have at least one lamp socket, and the lamp base is adapted to connect with the lamp socket to achieve electrical connection, wherein the type of the lamp base and socket is, for example, E14, E27, E40, or another appropriate type. Alternatively, the lamp socket may also be disposed on a conventional lamp support or a wall instead of the control unit 110, so that the light-emitting module 200 can be installed on the conventional lamp support or the wall. In the embodiment, except for providing the light-emitting module 200 with a required electric power, the control unit 110 is also used to control the light-emitting luminance, light-emitting color temperature, light-emitting color and light-emitting timing of the light-emitting module 200. In the embodiment, the control unit 110 is used to respectively control the light-emitting timings of the light-emitting modules 200. For example, the control unit 110 can control light-emitting at which time point and from which of the light-emitting modules 200. In other embodiments, the driving circuit board 250 can be electrically connected to the control unit 110 or other external powers through other conductive wires. In the embodiment, the control unit 110 can be, for example, a computer, a control host or other appropriate control devices.

In the embodiment, the hollow rod-shaped base 210 includes at least one conductive trace 216 electrically connected to the LED chips 220. The conductive trace 216 has a plurality of bonding spots 211 disposed at the inner surface 214 of the hollow rod-shaped base 210. The driving circuit board 250 is disposed in the space S and electrically connected to the conductive trace 216 through the bonding spots 211.

In the embodiment, the light-emitting module 200 further includes two caps 260 for covering both opposite ends of the hollow rod-shaped base 210 so as to close the space S. In addition, in the embodiment, the caps 260 and the hollow rod-shaped base 210 together form the closed space S with waterproof class of IP65 or more or waterproof class of IP66 or more so as to protect the electronic components in the space S, for example, the power unit 240 and the driving circuit board 250.

The light-emitting module 200 further includes a switch 270 disposed on one of the caps 260 and electrically connected to the LED chips 220. The switch 270 is used to control operation or non-operation of the light-emitting module 200. In addition, the light-emitting module can further include an adjustment component 280 disposed on one of the caps 260 and electrically connected to the LED chips 220 for adjusting the light-emitting intensity of the LED chips 220. In more details, the adjustment component 280 can adjust the current flowing through the LED chips 220 and further control the light-emitting intensity of the LED chips 220. The adjustment component 280 is, for example, a knob so that a user can rotate the knob to determine the light-emitting intensity of the LED chips 220. The adjustment component 280 can be a lever as well so that a user can shift the position of the lever to determine the light-emitting intensity of the LED chips 220. In other embodiments, the switch 270 and the adjustment component 280 can be integrated into a same component, for example, into a knob. When the knob is pressed down, the switch 270 is turned on, while the knob is rotated, the luminance of the LED chips 220 is adjusted. In another way, when the knob is slightly rotated, the switch 270 is turned on, and when the knob is continuously rotated, the luminance of the LED chips 220 is gradually increased. In the embodiment, a socket 310 can be disposed on one of the caps 260 and the socket 310 is electrically connected to the driving circuit board 250. The plug at one end of the USB can be plugged into the socket 310 so as to electrically connect the driving circuit board 250.

In the light source apparatus 100 of the embodiment, since the LED chips 220 are disposed in flip chip bonding way on the outer surface 212 of the hollow rod-shaped base 210, so that the light source apparatus 100 has both better appearance and good heat-dissipating efficiency. In addition, in the light source apparatus 100 of the embodiment of the invention, since the LED chips 220 are disposed surrounding the space S formed by the hollow rod-shaped base 210, the appearance and the application level of the light source apparatus 100 are effectively advanced. For example, each of the light-emitting modules 200 can serve as an omni-light-emitting lamp so as to increase the nice look of the light source apparatus 100. In addition, since the LED chips 220 are bonded in flip chip bonding way, so that the integral of the hollow rod-shaped base 210, the LED chips 220 and the phosphorous layer 230 has a smaller thickness T (as shown by FIG. 2B) and is more flat. In this way, any surface of the hollow rod-shaped base 210 can be horizontally placed on a table so that the light-emitting module 200 is used as a luminous paperweight. When the hollow rod-shaped base 210 adopts transparent material, the light-emitting module 200 has both luminousness and transparency so as to possess more nice look and artistic effect. The light source apparatus 100 can also include one light-emitting module 200 only; and at the time, the light-emitting module 200 is individually used and the power thereof is provided by a battery so that the light-emitting module 200 can serve as a portable luminous paperweight. In addition, the invention does not limit the size of the light-emitting module 200, which can have various sizes and be horizontally placed, upright placed or suspended to produce various lighting effects so as to achieve effect of beautifying the environment. When the light-emitting module 200 has a smaller size to be portable, the light-emitting module 200 can also serve as a light stick for traffic commanding, a light stick held by a viewer at a vocal concert or other tools with warning effect or visible effect.

Since the bonding spots 211 of the hollow rod-shaped base 210 are located at the inner surface 214, and since the embodiment can use the caps 260 to seal the space S, the light-emitting module 200 has waterproof and dustproof effect.

In the embodiment, the light-emitting module 200 further includes a wireless communication module 290 disposed in the space S and electrically connected to the LED chips 220. The control unit 110 can choose a wireless communication way to transmit a wireless signal to the wireless communication module 290 so as to control the LED chips 220, for example, to control the light-emitting luminance, light-emitting color temperature, light-emitting color and light-emitting timing of the light-emitting module 200. In other embodiments however, the light-emitting modules 200 can be configured without the wireless communication module 290, but remain wire way to electrically connect the control unit 110 for communication of electrical signals.

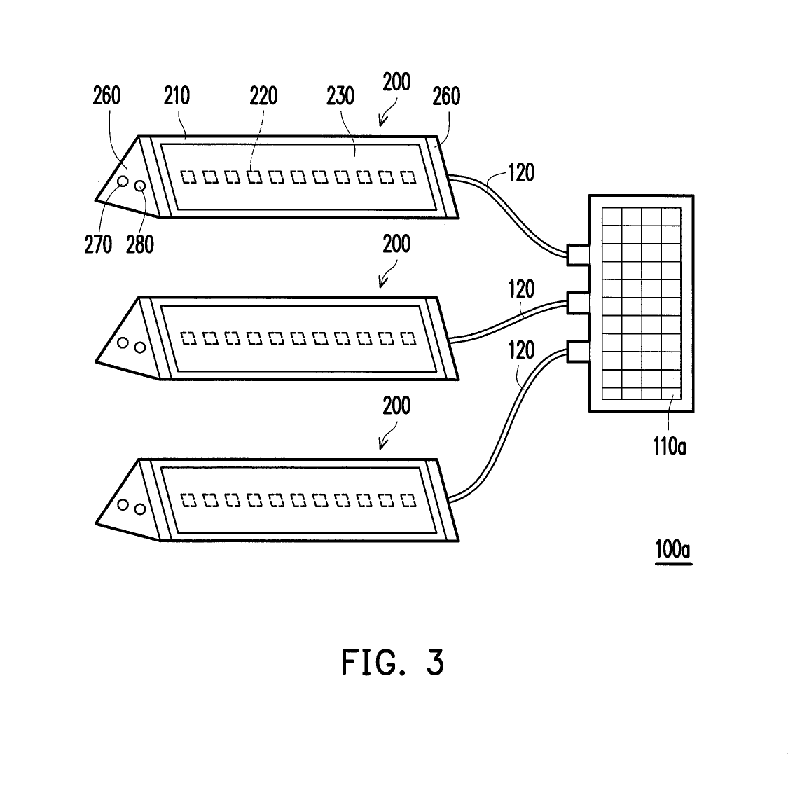

FIG. 3 is a schematic diagram of a light source apparatus according to another embodiment of the invention. Referring to FIG. 3, a light source apparatus 100a of the embodiment is similar to the light source apparatus 100 of FIG. 1 except that in the light source apparatus 100a of the embodiment, the light-emitting module 200 is electrically connected to a solar energy module 110a. In more details, the rechargeable battery in the light-emitting module 200 is electrically connected to the solar energy module 110a so that the rechargeable battery can be recharged with the solar energy.

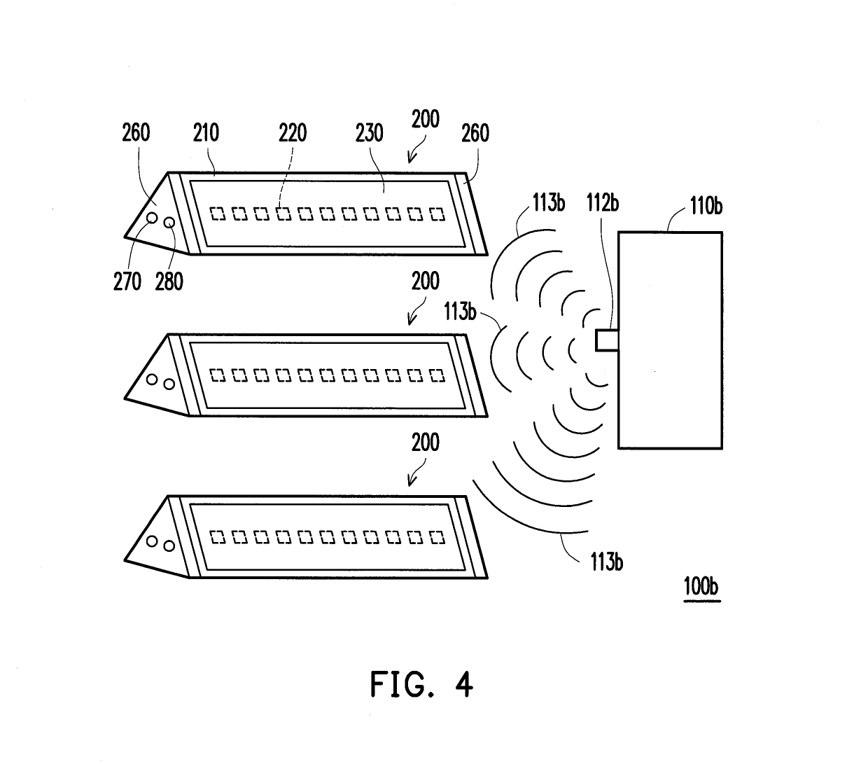

FIG. 4 is a schematic diagram of a light source apparatus according to yet another embodiment of the invention. Referring to FIG. 4, a light source apparatus 100b of the embodiment is similar to the light source apparatus 100 of FIG. 1, and in the light source apparatus 100b of the embodiment, a wireless communication module 112b (shown by FIG. 4) of the control unit 110b transmits a wireless signal 113b to the wireless communication modules 290 in the light-emitting modules 200 (referring to FIG. 2B) for controlling the light-emitting modules 200.

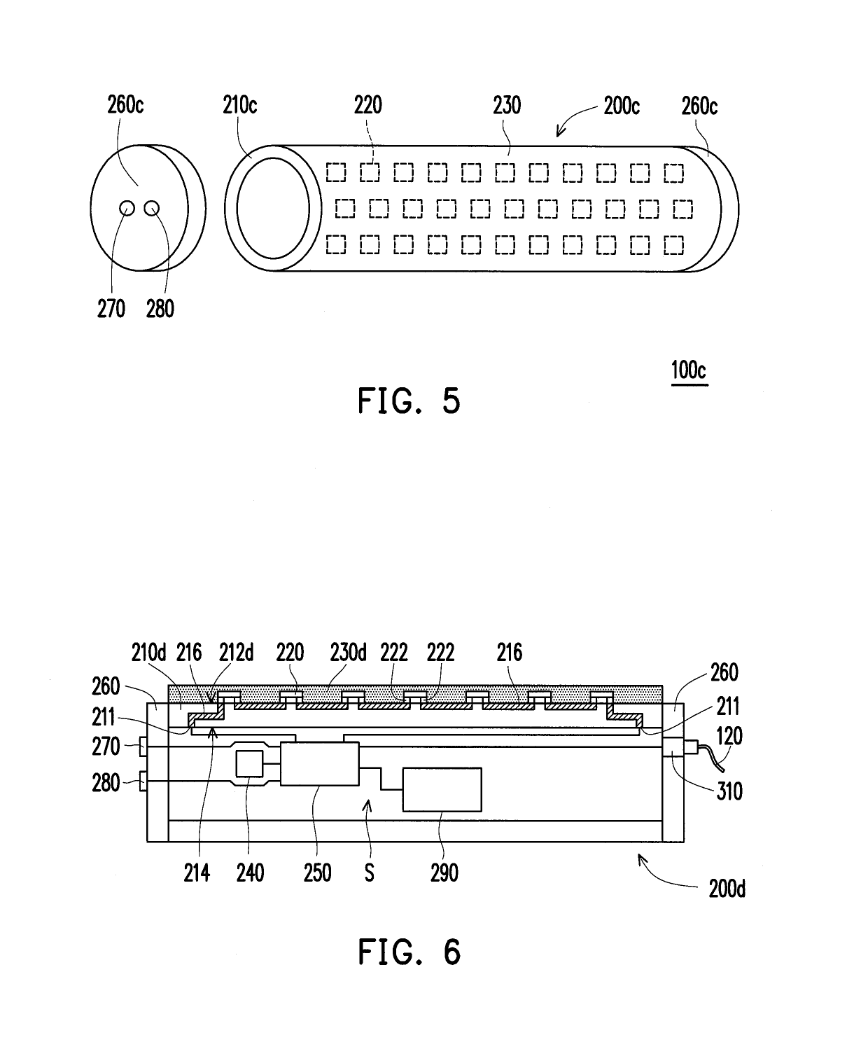

FIG. 5 is a three-dimensional diagram of a light source apparatus according to yet another embodiment of the invention. Referring to FIG. 5, a light-emitting module 200c of a light source apparatus 100c in the embodiment is similar to the light-emitting module 200 of FIG. 2A except that in the embodiment, the hollow rod-shaped base 210c thereof is in cylinder shape. In addition, the caps 260c are also in round plate shape to adapt the shape of the hollow rod-shaped base 210c. It should be noted that the invention does not limit the shape of the hollow rod-shaped base. In other embodiments, the hollow rod-shaped base can be in ellipse-pillar shape, other regular or irregular hollow pillar shapes.

FIG. 6 is a cross-sectional diagram of a light-emitting module according to yet another embodiment of the invention. Referring to FIG. 6, a light-emitting module 200d in the embodiment is similar to the light-emitting module 200 of FIG. 2B except that in FIG. 2B, the hollow rod-shaped base 210 of the light-emitting module 200 has a recess 213 on the outer surface 212 of the hollow rod-shaped base 210 and the LED chips 220 and the phosphorous layer 230 are disposed in the recess 213. In the light-emitting module 200d of the embodiment however, the outer surface 212d of the hollow rod-shaped base 210d does not have the recess 213 as FIG. 2B. In the embodiment, the outer surface 212d is, for example, a plane and the LED chips 220 and the phosphorous layer 230d are disposed on the outer surface 212d.

In summary, in the light source apparatus of the embodiment of the invention, since the LED chips are disposed in flip chip bonding way on the outer surface of the hollow rod-shaped base, so that the light source apparatus has both better appearance and good heat-dissipating efficiency. In addition, in the light source apparatus of the embodiment of the invention, since the LED chips surround the space formed by the hollow rod-shaped base, the appearance and the application level of the light source apparatus are effectively advanced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A light source apparatus, comprising:
at least one light-emitting module, comprising:
a hollow rod-shaped base, having an outer surface and an inner surface opposite to the outer surface, wherein the inner surface surrounds a space; and
a plurality of light emitting diode chips, disposed in flip chip bonding way on the outer surface of the hollow rod-shaped base, wherein the light emitting diode chips are disposed surrounding the space.

2. The light source apparatus as claimed in claim 1, wherein the light-emitting module further comprises a phosphorous layer disposed on the outer surface and covering the light emitting diode chips.

3. The light source apparatus as claimed in claim 1, wherein the light-emitting module further comprises a power unit disposed in the space and electrically connected to the light emitting diode chips.

4. The light source apparatus as claimed in claim 3, wherein the power unit comprises a rechargeable battery.

5. The light source apparatus as claimed in claim 4, further comprising a solar energy module electrically connected to the rechargeable battery.

6. The light source apparatus as claimed in claim 1, wherein the light-emitting module further comprises a driving circuit board disposed in the space and electrically connected to the light emitting diode chips.

7. The light source apparatus as claimed in claim 1, wherein the light-emitting module further comprises two caps covering both opposite ends of the hollow rod-shaped base to close the space.

8. The light source apparatus as claimed in claim 7, wherein the light-emitting module further comprises a switch disposed on one of the caps and electrically connected to the light emitting diode chips.

9. The light source apparatus as claimed in claim 7, wherein the light-emitting module further comprises an adjustment component disposed on one of the caps and electrically connected to the light emitting diode chips for adjusting light-emitting intensity of the light emitting diode chips.

10. The light source apparatus as claimed in claim 1, further comprising a control unit for controlling light-emitting luminance, light-emitting color temperature, light-emitting color and light-emitting timing of the light-emitting module.

11. The light source apparatus as claimed in claim 10, wherein the light-emitting module further comprises a driving circuit board disposed in the space and electrically connected to the light emitting diode chips and the control unit.

12. The light source apparatus as claimed in claim 11, wherein the control unit is electrically connected to the driving circuit board through a universal serial bus (USB).

13. The light source apparatus as claimed in claim 10, wherein the light-emitting module further comprises a wireless communication module disposed in the space and electrically connected to the light emitting diode chips, and the control unit wirelessly transmits a wireless signal to the wireless communication module for controlling the light emitting diode chips.

14. The light source apparatus as claimed in claim 1, wherein the at least one light-emitting module is a plurality of light-emitting modules and the light source apparatus further comprises a control unit for respectively controlling the light-emitting timings of the light-emitting modules.

15. The light source apparatus as claimed in claim 1, wherein a material of the hollow rod-shaped base comprises extruded aluminium alloy, aluminium alloy, heat-conducting plastic or ceramic.

16. The light source apparatus as claimed in claim 1, wherein the hollow rod-shaped base is in polygon pillar shape.

17. The light source apparatus as claimed in claim 16, wherein the hollow rod-shaped base is in triangle pillar shape.

18. The light source apparatus as claimed in claim 1, wherein the hollow rod-shaped base is in cylinder shape or in ellipse pillar shape.

19. The light source apparatus as claimed in claim 1, wherein the hollow rod-shaped base comprises at least one conductive trace, the conductive trace is electrically connected to the light emitting diodes and has a plurality of bonding spots, wherein the bonding spots are disposed at the inner surface of the hollow rod-shaped base, and the light-emitting module further comprises a driving circuit board disposed in the space and electrically connected to the conductive trace through the bonding spots.
